(19) United States
(12) Patent Application Publication
(10) Pub. No.: US 2026/0177764 A1
(43) Pub. Date: Jun. 25, 2026

(54) MULTI-SIGNAL TRANSMIT/RECEIVE OPTICAL STRUCTURE WITH IMPROVED MANUFACTURING AND ALIGNMENT CONVENIENCE

(71) Applicant: OPTICIS CO., LTD., Seongnam-si (KR)

(72) Inventors: Geun Han SONG, Namyangju-si (KR); Jong Ho LEE, Seoul (KR)

(73) Assignee: OPTICIS CO., LTD., Seongnam-si (KR)

(21) Appl. No.: 19/335,352

(22) Filed: Sep. 22, 2025

(30) Foreign Application Priority Data
Dec. 20, 2024 (KR) 10-2024-0192507

(51) Int. Cl. G02B 6/42

(52) U.S. Cl. CPC G02B 6/4215

(57) ABSTRACT

The present disclosure provides a multi-signal transmit/receive optical structure with improved manufacturing and alignment convenience. According to one aspect of the present embodiment, a multi-signal transmit/receive optical structure is provided that enhances manufacturing and alignment convenience, thereby reducing manufacturing costs and improving yield and performance.

### CROSS-REFERENCE TO RELATED APPLICATION

The present application claims priority under 35 U.S.C. § 119(a) to Korean Patent Application No. 10-2024-0192507 filed in the Korean Intellectual Property Office on Dec. 20, 2024, the entire disclosure of which is incorporated herein by reference.

### BACKGROUND

### 1. Technical Field

The present embodiment relates to a multi-signal transmit/receive optical structure with improved manufacturability and alignment.

### 2. Related Art

The content described in this section is merely to provide background information for the present embodiment and does not constitute prior art.

In Wavelength Division Multiplexing (WDM) optical communication systems, multiple optical carriers of different wavelengths provide independent communication channels within a single optical fiber. The demand for communication link bandwidth in such systems is continuously increasing. Generally, optical fibers offer significantly higher bandwidth than conventional coaxial communication. Furthermore, a single optical channel in an optical fiber waveguide utilizes a very small portion of the fiber's available bandwidth, typically a few gigahertz (GHz) out of several tens of terahertz (THz). In conventional communication systems, this bandwidth can be utilized more efficiently by transmitting multiple channels of different optical wavelengths through the optical fiber using “Wavelength Division Multiplexing” or “WDM” technology.

In general operation, an optical multiplexing device (or optical coupler) combines or separates multiple optical signals having various optical frequencies or wavelengths. Such optical multiplexing devices can be applied to multi-mode and single-mode optical fiber data communications, as well as to Dense Wavelength Division Multiplexing (DWDM) and Coarse Wavelength Division Multiplexing (CWDM) for communications. Light of multiple wavelengths can be combined into a single optical path for transmission, and light of multiple wavelengths traveling along a single optical path can be separated into several narrow spectral bands.

Conventional optical couplers suffer from significant difficulties in aligning the components for separating incident light by wavelength band, the optical components for adjusting this component and the optical path (e.g., lenses), and each component with the coupler body. Conventionally, in the manufacturing process of an optical coupler, the aforementioned components were placed and aligned manually, one by one. This manual alignment process was not only time-consuming but also led to the manufactured optical coupler having tolerances that deviated from the design specifications.

### SUMMARY

An object of an embodiment of the present invention is to provide a multi-signal transmit/receive optical structure that improves manufacturing and alignment convenience, thereby reducing manufacturing costs and enhancing yield and performance.

According to one aspect of the present embodiment, there is provided an optical coupler for separating light emitted from an optical fiber according to wavelength bands to direct it to respective optical elements within a substrate part, or for combining light of respective wavelength bands emitted from the respective optical elements within the substrate part to direct it into the optical fiber, the optical coupler comprising: a body; an optical fiber inlet formed at one end of the body, configured to allow the optical fiber to be inserted into the optical coupler; a plurality of first lenses formed on a bottom surface of the body, configured to focus light proceeding toward the respective optical elements or to prevent divergence of light emitted from the respective optical elements from diverging and to guide the light toward the optical fiber; a plurality of second lenses formed on a surface opposite to the bottom surface of the body at positions corresponding to the respective first lenses, configured to focus light proceeding toward the respective optical elements or to prevent light emitted from the respective optical elements from diverging and direct it toward the optical fiber; and a third lens configured to focus light emitted from the respective optical elements into the optical fiber or to prevent the divergence of light emitted from the optical fiber, wherein each component within the optical coupler is integrally manufactured from a same material by molding.

According to another aspect of the present embodiment, each component within the optical coupler is made of a lens material.

According to another aspect of the present embodiment, the plurality of first lenses are disposed at positions facing the respective optical elements.

According to another aspect of the present embodiment, the third lens is provided on an optical axis of the optical fiber.

According to another aspect of the present embodiment, the third lens is provided to face the optical fiber inserted through the optical fiber inlet.

According to another aspect of the present embodiment, the optical fiber inlet comprises an optical fiber inlet hole implemented with a predetermined depth from one end of the body in a direction opposite to the body.

According to another aspect of the present embodiment, the optical fiber inlet hole has a diameter identical to a diameter of the optical fiber.

According to another aspect of the present embodiment, the optical fiber inlet hole is provided at a position where light emitted from the respective optical elements is focused.

According to another aspect of the present embodiment, the optical fiber inlet further comprises an optical fiber support jaw provided at a predetermined depth from the optical fiber inlet hole in the opposite direction of the body.

According to another aspect of the present embodiment, the optical fiber support jaw has a structure protruding inward from the optical fiber inlet hole, thereby preventing the optical fiber from advancing further into the body.

As described above, according to one aspect of the present embodiment, there are advantages in that the convenience of manufacturing and alignment is improved, thereby reducing manufacturing costs and enhancing yield and performance.

### BRIEF DESCRIPTION OF THE DRAWINGS

FIG. 1 is a diagram illustrating the configuration of a multi-signal transmit/receive optical structure according to an embodiment of the present invention.

FIG. 2 is a diagram illustrating the configuration of a substrate part according to an embodiment of the present invention.

FIG. 3 is a perspective view of an optical coupler according to an embodiment of the present invention.

FIG. 4 is a plan view of the optical coupler according to an embodiment of the present invention.

FIG. 5 is a bottom view of the optical coupler according to an embodiment of the present invention.

FIG. 6 is a side view of the optical coupler according to an embodiment of the present invention.

FIG. 7 is a cross-sectional view of the optical coupler according to an embodiment of the present invention.

FIGS. 8 and 9 are enlarged views of a portion of the optical coupler according to an embodiment of the present invention.

FIG. 10 is a diagram illustrating the operation of the optical coupler according to an embodiment of the present invention.

### DETAILED DESCRIPTION

The present disclosure may be changed in various ways and may have various embodiments. Specific embodiments are to be illustrated in the drawings and specifically described. It should be understood that the present disclosure is not intended to be limited to the specific embodiments, but includes all of changes, equivalents and/or substitutions included in the spirit and technical range of the present disclosure. Similar reference numerals are used for similar components while each drawing is described.

Terms, such as a first, a second, A, and B, may be used to describe various components, but the components should not be restricted by the terms. The terms are used to only distinguish one component from another component. For example, a first component may be referred to as a second component without departing from the scope of rights of the present disclosure. Likewise, a second component may be referred to as a first component. The term “and/or” includes a combination of a plurality of related and described items or any one of a plurality of related and described items.

When it is described that one component is “connected” or “coupled” to the other component, it should be understood that one component may be directly connected or coupled to the other component, but a third component may exist between the two components. In contrast, when it is described that one component is “directly connected to” or “directly coupled to” the other component, it should be understood that a third component does not exist between the two components.

Terms used in this application are used to only describe specific embodiments and are not intended to restrict the present disclosure. An expression of the singular number includes an expression of the plural number unless clearly defined otherwise in the context. In the present specification, a term, such as “include” or “have”, is intended to designate the presence of a characteristic, a number, a step, an operation, a component, a part described in the present specification or a combination of them, and should be understood that it does not exclude the possibility of the existence or addition of one or more other characteristics, numbers, steps, operations, components, parts, or combinations of them in advance.

All terms used herein, including technical or scientific terms, have the same meanings as those commonly understood by a person having ordinary knowledge in the art to which the present disclosure pertains, unless defined otherwise in the specification.

Terms, such as those defined in commonly used dictionaries, should be construed as having the same meanings as those in the context of a related technology, and are not construed as ideal or excessively formal meanings unless explicitly defined otherwise in the application.

Furthermore, each construction, process, procedure, or method included in each embodiment of the present disclosure may be shared within a range in which the constructions, processes, procedures, or methods do not contradict each other technically.

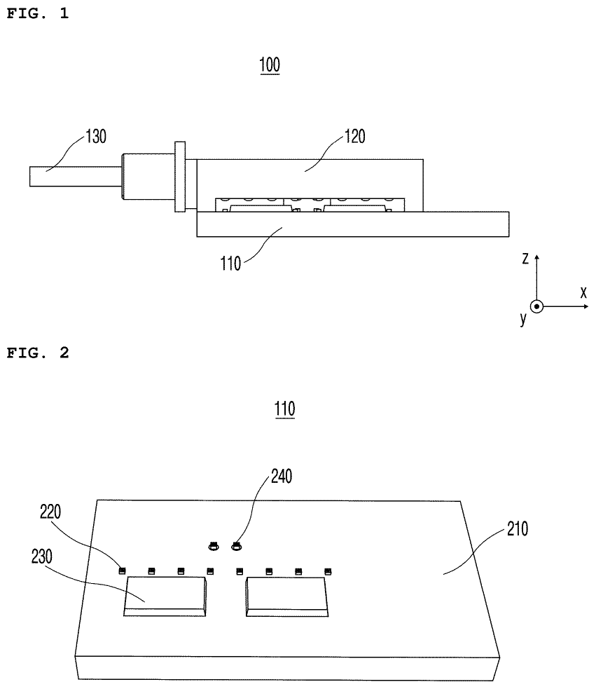

FIG. 1 is a diagram illustrating the configuration of a multi-signal transmit/receive optical structure according to an embodiment of the present invention.

Referring to FIG. 1, the multi-signal transmit/receive optical structure 100 according to an embodiment of the present invention includes a substrate part 110, an optical coupler 120, and an optical fiber 130.

The multi-signal transmit/receive optical structure 100 separates light emitted from a component within a Wavelength Division Multiplexing (WDM) optical communication system by wavelength band and directs it to other components, or combines light of respective wavelength bands emitted from certain components and directs it to another component.

In this case, because the multi-signal transmit/receive optical structure 100 includes the substrate part 110 and the optical coupler 120, it can be manufactured and aligned through a significantly simplified procedure compared to the prior art. In particular, by including the optical coupler 120 having the structure to be described later, the multi-signal transmit/receive optical structure 100 can be manufactured and aligned in an automated manner rather than by manual labor. Accordingly, the multi-signal transmit/receive optical structure 100 can have significantly reduced manufacturing costs and time (yield), while the manufactured final product can have significantly improved quality.

The substrate part 110 outputs light of each wavelength band to be emitted to the optical fiber 130, or receives light emitted from the optical fiber 130 and separated by wavelength band. The substrate part 110 is implemented as shown in FIG. 2.

FIG. 2 is a diagram illustrating the configuration of the substrate part according to an embodiment of the present invention.

Referring to FIG. 2, the substrate part 110 according to an embodiment of the present invention includes a substrate 210, optical elements 220, a control IC 230, and a first reference point 240.

The substrate 210 provides a space for implementing each component within the substrate part 110.

The optical elements 220 receive light that has been emitted from the optical fiber 130 and passed through the optical coupler 120, or they output light that will be incident on the optical fiber 130 after passing through the optical coupler 120. When operating within the multi-signal transceiver optical structure 100 to receive light from each wavelength band separated by the optical coupler 120 after being injected from the optical fiber 130, the optical element 220 is implemented as a receiving element (e.g., a photodiode) or functions as a receiving element to receive the light. Conversely, when operating to output light into the optical fiber 130 within the multi-signal transceiver optical structure 100, the optical element 220 is implemented as a light source or functions as a light source, emitting light. The optical elements 220 are implemented in a number corresponding to the number of combined wavelength bands or the number of wavelength bands to be combined, and they receive or output light of each wavelength band.

The optical elements 220 are arranged at predetermined positions on the substrate 210 with respect to the first reference point 240. Each of the optical elements 220 is arranged at a predetermined position (coordinate) on the substrate 210 based on the coordinates of the first reference point 240. Accordingly, even if only the first reference point 240 is recognized externally, it is possible to ascertain at which coordinates each optical element 220 is located on the substrate 210.

The control IC 230 controls the operation of each optical element 220 and performs signal processing for the operation of the optical element 220. One or more control ICs 230 are arranged within the substrate part 110 to control the operation of each optical element 220. When the optical element 220 is implemented as a light-receiving element, the control IC 230 controls the optical element 220 to receive light and performs appropriate signal processing on the received light signals. Conversely, when the optical element 220 is implemented as a light source, the control IC 230 performs appropriate signal processing to generate signals to be transmitted to the optical element 220, and controls the optical element 220 to emit light at the appropriate time.

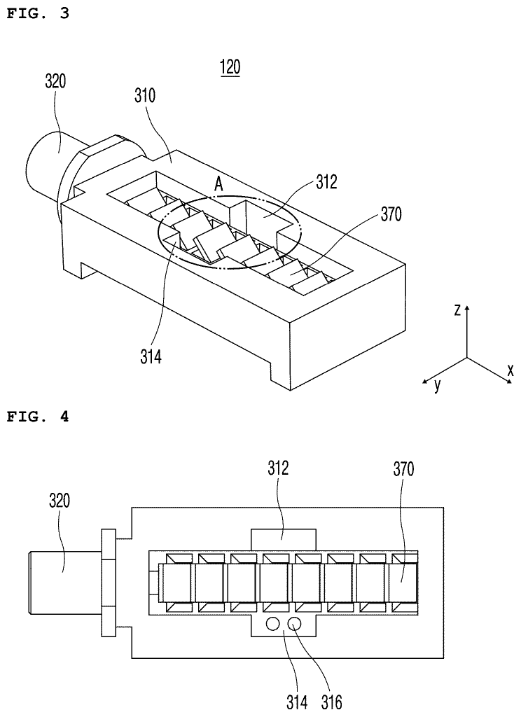

The first reference point 240 is arranged at a predetermined position on the substrate 210 and indicates its own position and the position of the optical elements 220 to an external system. Here, the predetermined position may be a position facing a through-hole 312 within the optical coupler 120, to be described later with reference to FIG. 3, when the optical coupler 120 is arranged in its proper position on the substrate 210. That is, since the first reference point 240 is at a position facing the through-hole 312 within the substrate 210 (ultimately), it is possible to easily recognize the first reference point 240 from the outside even when the optical coupler 120 is placed on the substrate part 110, and accordingly, the position (coordinates) of each optical element 220 can also be recognized.

Referring back to FIG. 1, the optical coupler 120 allows the optical fiber 130 to be inserted into a certain position thereof and to be fixed. Accordingly, the optical coupler 120 separates the light emitted from the optical fiber 130 by wavelength band and directs it to the substrate part 110, or combines the light of each wavelength band emitted from the substrate part 110 and directs it to the optical fiber 130. The optical coupler 120 is provided with a structure as shown in FIGS. 3 to 9, can be manufactured with a significantly simplified procedure and can include precisely aligned components. The structure and operation of the optical coupler 120 will be described later with reference to FIGS. 3 to 9.

The optical fiber 130 is disposed within the optical coupler 120 to emit light to the optical coupler 120 or to receive and transmit light that is incident through the optical coupler 120.

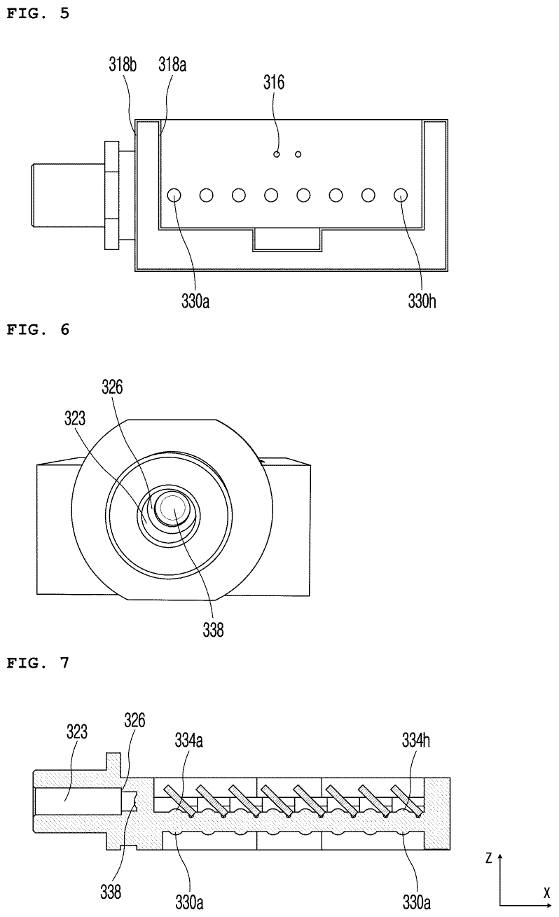

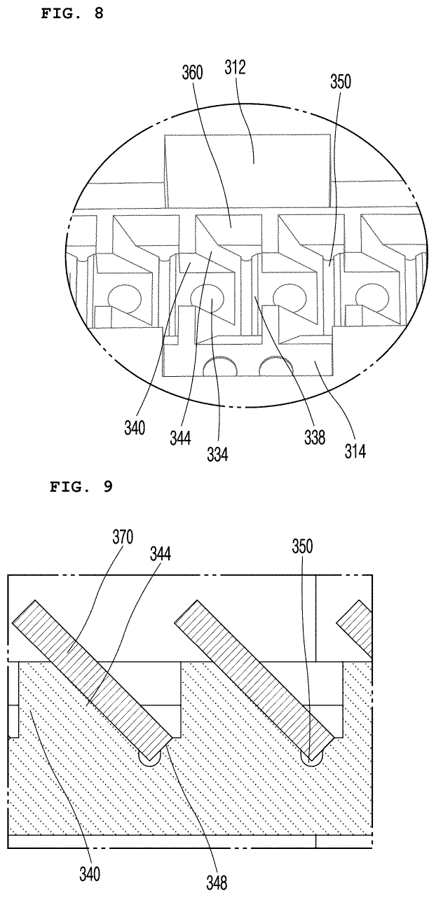

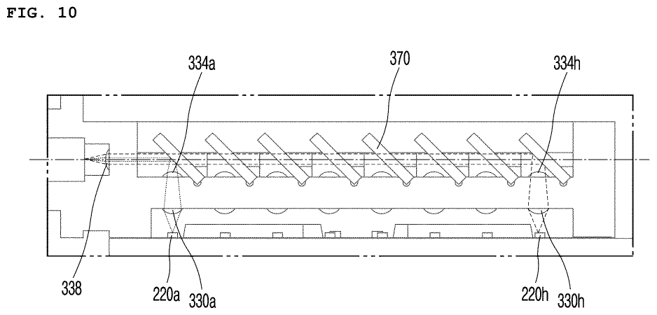

FIG. 3 is a perspective view of an optical coupler according to an embodiment of the present invention, FIG. 4 is a plan view, FIG. 5 is a bottom view, FIG. 6 is a side view, FIG. 7 is a cross-sectional view, FIGS. 8 and 9 are enlarged views of a portion thereof, and FIG. 10 is a diagram illustrating the operation of the optical coupler.

Referring to FIGS. 3 to 9, the optical coupler 120 according to an embodiment of the present invention includes a body 310, an optical fiber inlet 320, lens parts 330, 334, 338, an arranging part 340, an adhesive placement part 350, and an adhesive injection part 360.

The body 310 provides the space for implementing each component within the optical coupler 120. In this case, all components of the optical coupler 120, including the body 310, are integrally manufactured from the same material by molding. Since at least the lens parts 330, 334, 338 must be capable of adjusting the optical path, all components of the optical coupler 120 including the body 310 are implemented with a lens material (i.e., a material that allows light to pass through and adjusts the path of light according to its refractive index and shape, such as Ultem). There is no need to separately arrange the lens parts 330, 334, 338 within the body 310, and there is no need to align each of them during the arrangement process. Accordingly, the manufacturing and alignment of the optical coupler 120 can be significantly simplified compared to the prior art.

Referring to FIGS. 3 and 4, the body 310 includes a through-hole 312 at a predetermined position. Here, the predetermined position may be a position facing the first reference point 240 from the outside (especially, from the vertically upward direction) when the lenses 330, 334 are arranged in the proper position facing the optical elements 220. The through-hole 312 is formed at the aforementioned position on the periphery of the arranging part 340 within the body 310, allowing the first reference point 240 to be recognized through the body 310 from the vertically upward side of the optical coupler 120. When a separate device grips the optical coupler 120 and moves it onto the substrate 110 to place it in its proper position, the positions of the lenses 330, 334 and the optical elements 220 can be aligned based on the position of the first reference point 240 beyond the through-hole 312.

Referring to FIGS. 3 and 4, a groove 314 is formed at a position opposite the through-hole 312 within the body 310, and a second reference point 316 is formed on the upper surface of the groove 314. The body 310 includes the groove 314, which has the same or a similar (cross-sectional) area as the through-hole 312, at a position opposite the through-hole 312 with the arranging part 340 as the center. The second reference point 316 is formed on the upper surface of the groove 314. The second reference point 316 may be implemented in a protruding form on the upper surface of the groove 314, or it may be implemented as a concave groove. If implemented as a protruding form on the upper surface of the groove 314, the second reference point 316 may appear as a concave groove on the bottom surface of the body 310 (the surface in contact with the substrate 110), and vice versa.

When the lenses 330, 334 are arranged in their proper positions facing the optical elements 220, the second reference point 316 is formed at predetermined coordinates based on the positions of the optical elements 220. As described above, even if the body 310 is implemented with a material that allows light to pass through, it is not easy to observe from the outside whether the lenses 330, 334 are arranged in their proper positions facing the optical elements 220 due to the structure of the lenses 330, 334. That is, during the process of placing the optical coupler 120 on the substrate 110 based on the first reference point 240, the optical coupler 120 may be placed in a skewed position. To resolve this issue, when the optical coupler 120 is placed on the substrate 110, the second reference point 316 allows for determining whether the lenses 330, 334 have been accurately placed in their proper positions. Since the second reference point 316 is formed at predetermined coordinates based on the positions of the optical elements 220, and the optical elements 220 are formed at predetermined coordinates in relation to the first reference point 240, ultimately, the second reference point 316 must be located at coordinates determined in relation to the first reference point 240. By checking the first reference point 240 and the second reference point 316 when placing the optical coupler 120 in its proper position on the substrate 110 from the outside, it can be accurately placed in the proper position.

Referring to FIG. 5, steps 318a, 318b are formed on the bottom surface of the body 310 (the surface in contact with the substrate 110).

When the optical coupler 120 is placed in the aforementioned proper position on the substrate 110, the step 318a is implemented on the bottom surface of the body 310 at the location where the optical elements 220, the control IC 230, and the first reference point 240 are placed, with an area equal to or greater than the area where each component 220 to 240 is placed. By including the step 318a, the body 310 allows the optical coupler 120 to be placed on the substrate 110 without damaging the components 220 to 240.

The step 318b is formed at each end (peripheral portion) of the upper surface of the step 318a within the bottom surface of the body 310. By forming the step 318b at each end (peripheral portion) of the upper surface of the step 318a, it prevents the adhesive applied to the upper surface of the step 318a from escaping. Even if an adhesive for bonding with the substrate 110 is applied to the bottom surface of the body 310, specifically to the upper surface of the step 318a, if the step 318b does not exist, the adhesive may not remain fixed on the upper surface of the step 318a and may escape from between the two (the substrate and the optical coupler) due to pressure. Consequently, the adhesive force between the two entities can be significantly reduced. By including the step 318b, the body 310 prevents the adhesive applied to the upper surface of the step 318a from escaping from between the two entities (substrate and optical coupler).

On the upper surface of the step 318a, i.e., on a part or all of the surface of the internal space formed by the step 318b, fine-sized grooves (not shown) in various shapes such as a cross (+) shape or an X shape may be formed. If the grooves (not shown) are formed on the said surface, a larger amount of adhesive can be applied, thereby improving the adhesive strength between the two entities (substrate and optical coupler).

Referring to FIGS. 3 and 6, the optical fiber inlet 320 is formed at one end of the body 310 and allows the optical fiber 130 to be inserted into the optical coupler 120. The optical fiber inlet 320 includes an optical fiber inlet hole 323 and an optical fiber support jaw 326.

The optical fiber inlet hole 323 is implemented with a predetermined depth from the end of the optical fiber inlet 320 in the opposite direction of the body 310, allowing the optical fiber 130 to be inserted therein. The optical fiber inlet hole 323 has a diameter identical to that of the optical fiber 130 and is implemented as described above. Accordingly, it allows the optical fiber 130 to be inserted from the optical fiber inlet hole 323 to the optical fiber support jaw 326.

The optical fiber inlet hole 323 is implemented at one end of the body 310, at a position where the light emitted from the optical elements 220 is focused or at a position where the light to be emitted to the optical elements 220 will be incident on each optical element 220 when placed in the aforementioned proper position. By implementing the optical fiber inlet hole 323 at this position, the optical fiber 130 can be located at the aforementioned position.

The optical fiber support jaw 326 is implemented at a predetermined depth from the optical fiber inlet hole 323 in the opposite direction of the body 310 and prevents the optical fiber 130 from advancing beyond it in the direction of the body 310. The optical fiber support jaw 326 has a structure that protrudes inward from the optical fiber inlet hole 323 at the aforementioned depth. Accordingly, as the optical fiber 130 inserted through the optical fiber inlet hole 323 advances along the optical fiber inlet hole 323, it comes into contact with the optical fiber support jaw 326. Consequently, the optical fiber 130 is prevented from advancing further in the opposite direction of the body 310 by the optical fiber support jaw 326, and it is fixed and supported at that position in contact with the optical fiber support jaw 326 by the optical fiber inlet hole 323 and the optical fiber support jaw 326.

The lens parts 330a to 330h are implemented on the bottom surface of the body 310 to focus the light proceeding to the optical elements 220 onto the optical elements 220, or to cause the light emitted from the optical elements 220 to proceed toward the optical fiber 130 without diverging.

The lens parts 330a to 330h are implemented integrally on the bottom surface of the body 310. As described above, the lens parts 330a to 330h are manufactured simultaneously with the body 310 within the body 310 by a mold.

When the substrate 110 and the optical coupler 120 are arranged in their proper positions, the lens parts 330a to 330h are arranged at positions facing the respective optical elements 220. The lens parts 330a to 330h, being arranged at these positions, focus the light that has been emitted from the optical fiber 130 and separated by each filter 370, onto the optical elements 220. Alternatively, they collimate the light emitted from each optical element 220, so that the light, after being reflected by each filter 370, is focused into the optical fiber 130 by passing through the respective lenses 334, 338.

The lens parts 334a to 334h are implemented on the upper surface of the body 310 (the side opposite the bottom surface) at positions corresponding to or vertically facing the lens parts 330a to 330h. Similar to the lens parts 330a to 330h, the lens parts 334a to 334h focus the light proceeding to the optical elements 220 onto the optical elements 220, or cause the light emitted from the optical elements 220 to proceed toward the optical fiber 130 without diverging.

The lens parts 334a to 334h are implemented integrally on the upper surface of the body 310. The lens parts 334a to 334h are also manufactured simultaneously by molding. Accordingly, not only is the manufacturing of the lenses 330, 334 simplified, but the placement of the lenses can also be simplified. To adjust the optical path, the lenses must be precisely arranged, and if an error occurs in the arrangement, a tolerance is generated. However, since the lenses 330, 334 are manufactured by molding and are located in their proper positions within the body 310 from the time of manufacture, there is no need to separately arrange the lenses 330, 334 in the body 310, no difficulties exist in alignment, and no tolerance is generated during the alignment process.

Meanwhile, the size (diameter) of the lenses within the lens parts 330a to 330h and 334a to 334h may be implemented to be identical, but they may also be implemented such that the size (diameter) of the lenses gradually increases as the distance from the optical fiber inlet 320 increases. The propagation of light within the optical coupler is illustrated in FIG. 10.

The example shown in FIG. 10 assumes a situation where light emitted from the optical fiber 130 is reflected by each filter 370 and proceeds to the optical elements 220a to 220h. In this situation, the light emitted from the optical fiber 130 passes through the lens 338, and as it passes through each filter 370, the beam width of the light increases with the distance from the optical fiber inlet 320 or the lens 338. Consequently, if the sizes of all lenses within the lens parts 330a to 330h and 334a to 334h are implemented to be the same, a problem may arise where not all of the light incident on the lens parts 330h, 334h can be fully focused onto the optical element 220h. Recognizing that the beam width of the propagating light increases as the distance from the optical fiber inlet 320 increase, the size of the lenses within the lens parts 330a to 330h and 334a to 334h can also be implemented to gradually increase according to the direction of light propagation. Accordingly, the lens parts 330a to 330h and 334a to 334h at each position can fully focus the light onto the optical fiber 130 or the optical elements 220.

Referring to FIGS. 3, 6, and 7, the lens part 338 is implemented within the body 310 between the filter 370 arranged in the arranging part 340 and the optical fiber 130 inserted through the optical fiber inlet 320, or it is implemented to face the optical fiber 130 inserted through the optical fiber inlet 320. The lens part 338 focuses the light emitted from the optical elements 220 into the optical fiber 130 or prevents the divergence of light emitted from the optical fiber 130. The lens part 338 is implemented on the optical axis of both components, between the filter 370 and the optical fiber 130 within the body 310, and adjusts the path of the light incident on it as described above.

Referring to FIGS. 8 and 9, the arranging part 340 is implemented on the upper surface of the body 310 to arrange the filter 370.

The arranging part 340 is arranged in parallel in a direction perpendicular to the direction of light propagation (excluding the vertical direction) on the upper surface of the body 310 with respect to the lens 334. The arranging part 340 has a structure that protrudes vertically upward from the upper surface of the body 310 in a trapezoidal shape. The arranging part 340 may protrude in a trapezoidal shape with two inclined surfaces, but to reduce its structural size, it may protrude in a trapezoidal shape with one inclined surface 344. In this case, the angle between the upper surface of the body 310 and the inclined surface 344 is implemented to be 45° . Accordingly, a filter 370 seated on the arranging part 340 can receive incident light, filter it, and reflect the filtered light vertically downward, more specifically, to the lens parts 334a to 334h.

The arranging part 340 may include a filter support part 348 on the side opposite to the side where the inclined surface 344 is implemented. The filter support part 348 is implemented on the side opposite to the side where the inclined surface 344 of the arranging part 340 is implemented, and it is implemented in a direction perpendicular to the inclined surface 344 at a position lower than the lowest end (in the vertical direction) of the inclined surface 344. That is, the inclined surface 344 of one adjacent arranging part 340 and the filter support part 348 of the adjacent arranging part 340 are located apart from each other, forming a right angle. The filter 370 is placed along the inclined surface 344 of one arranging part 340,, and in the vertically downward direction, it is in contact with and supported by the filter support part 348 of the adjacent arranging part 340. Accordingly, as shown in FIG. 9, the filter 370 can be placed and seated along the inclined surface of each arranging part 340 as described above.

The adhesive placement part 350 is a groove implemented between the inclined surface 344 of one arranging part 340 and the filter support part 348 of the adjacent arranging part 340, and forms a space where the filter 370 to be placed on each arranging part 340 and the adhesive to be injected for fixing the filter 370 will be placed. As will be described later, the filter 370 is implemented in a hexahedron shape. If manufactured ideally, the filter 370 should be implemented in the shape of a hexahedron with smooth edges. However, in the actual manufacturing process, it is not easy for the filter 370 to be implemented in the shape of a hexahedron, but it is frequent that each edge is not implemented with a perfectly smooth right angle. Accordingly, if the inclined surface 344 of adjacent arranging parts 340 and the filter support part 348 are implemented to be physically connected without the adhesive placement part 350, a filter 370 whose edges are not implemented in a smooth right-angled form will generate a minute error when placed at that position. Recognizing this problem, the adhesive placement part 350 prevents the relevant edge portion of the filter 370 from coming into contact with separate components (344, 348) when the filter 370 is in contact with and supported by the inclined surface 344 and the filter support part 348 of adjacent arranging parts 340. Accordingly, the filter 370 can be arranged at a precise angle by only contacting the two components 344, 348 implemented in the vertical direction.

Furthermore, when the filter 370 is placed at the aforementioned position and bonded with the arranging parts 340 with an adhesive, the adhesive undergoes a volume change during the curing process. Typically, epoxy, which is commonly used as an adhesive, has the property of shrinking as it cures. Accordingly, if the adhesive placement part 350 does not exist, a problem may arise where the filter 370 deviates from its proper position due to the volume change of the adhesive during the process of being placed at the said position and bonded by the adhesive. In contrast, with the implementation of the adhesive placement part 350, the remaining adhesive, other than the adhesive for bonding the filter 370 at the aforementioned position, is located in the adhesive placement part 350. At this time, even if the adhesives placed in the adhesive placement part 350 change in volume as they cure, the force applied to the filter 370 due to the volume change is mainly applied in the vertically downward direction. Accordingly, when the filter 370 is placed at the aforementioned position, it is possible to minimize the deviation of the filter 370 from the precise angle (45°) due to the volume change that occurs during the curing process of the adhesive.

Referring to FIG. 8, the adhesive injection part 360 is implemented on the side surface of each arranging part 340 within the body 310, allowing adhesive to be injected into the adhesive placement part 350. The adhesive injection part 360 is implemented in the shape of an inclined surface on the side of each arranging part 340 within the body 310. If there is no gap between the filter 370 and the body 310 in the situation where the filter 370 is placed at the aforementioned position, it is difficult for the adhesive to be fully injected into the adhesive placement part 350. Therefore, the adhesive injection part 360 is implemented in the form of an inclined surface that becomes farther apart (between the facing adhesive injection parts 360) as it goes vertically upward at the said position (on the side of each arranging part within the body). Even if the filter is placed and there is no gap on the side of the filter 370 and the body 310, the adhesive can be injected through the adhesive injection part 360.

Meanwhile, as shown in FIGS. 8 to 10, the filter 370 is placed at the position between each arranging part 340. The filter 370 is implemented in a hexahedron shape, and includes a filter part on one surface (specifically, the surface that does not contact the inclined surface 344 of the arranging part 340 where the filter 370 placed between each arranging part 340 is located) that reflects only light of a specific wavelength band. Each filter 370 filters light of a different specific wavelength band and reflects the light of the remaining wavelength bands. Since the filter 370 is placed on the inclined surface 344 of one arranging part 340 and supported by the filter support part 348 of the adjacent arranging part 340 as described above, the filter 370 is placed at an 45° angle without error. More specifically, the filter 370 is placed at an 45° angle without error at the intersection point of the optical axis passing through each lens part 330, 334 via the optical elements 220 and the optical axis of the light emitted from the optical fiber 130. Accordingly, it is possible to reflect the light (of a specific wavelength band) emitted from one side to the other side without error. Referring to FIG. 10, Assuming a situation where light is emitted from the optical fiber 130, each filter 370 is placed at the aforementioned position, and reflects only the light of a specific wavelength band among the light emitted from the optical fiber 130 to the lens 334. Accordingly, the corresponding light passes through the lens 334 and the lens 330 and is incident on the optical element 220. Conversely, assuming a situation where light is emitted from the optical element 220, each filter 370 is placed at the aforementioned position, and reflects the light that has been emitted from the optical element 220 and passed through each lens 330, 334 to the optical fiber 130. Since each filter 370 reflects only light of a different specific wavelength band and transmits the light of the remaining wavelength bands, it can operate as described above.

The substrate 110, the optical coupler 120, and the filter 370 having the aforementioned configuration can be arranged as follows.

First, each element 220 and 230 is arranged on the substrate 210 of the substrate part 110 based on the position of the first reference point 240.

Thereafter, an adhesive is applied to the remaining positions on the substrate part 110, and the optical coupler 120 is placed in its proper position on the substrate 210. The optical coupler 120 can be easily moved to its proper position by observing the first reference point 240 and the second reference point 316.

The optical coupler 120 is bonded on the substrate 110 (in its proper position), and an additional adhesive may be applied to the edge of the bonding surface of the substrate 110 and the optical coupler 120.

Thereafter, each filter 370 is placed in the space between both arranging parts 340 of the optical coupler 120, and the adhesive is injected through the adhesive injection part 360 to bond the filter 370.

Since the optical coupler 120 is implemented (manufactured by molding) as described above, the manufacturing can also be easily carried out. In addition, since the optical coupler 120 does not require the process of aligning each component, especially the lenses 330, 334, 338, the alignment process can also be significantly simplified compared to the prior art.

While the foregoing description has been presented by way of illustration of the technical spirit of the present embodiment, it will be understood by those skilled in the art to which the present embodiment pertains that various changes and modifications may be made without departing from the essential characteristics of the present embodiment. Therefore, the disclosed embodiments are intended to illustrate rather than limit the technical spirit of the present embodiment, and the scope of the technical spirit of the present embodiment is not limited by these embodiments. The scope of protection of the present embodiment should be interpreted by the following claims, and all technical ideas within the scope equivalent thereto should be interpreted as being included in the scope of rights of the present embodiment.

What is claimed is:

1. An optical coupler for separating light emitted from an optical fiber according to wavelength bands to direct the light to respective optical elements within a substrate part, or for combining light of respective wavelength bands emitted from the respective optical elements within the substrate part to direct the light into the optical fiber, the optical coupler comprising:
a body;
an optical fiber inlet formed at one end of the body, configured to allow the optical fiber to be inserted into the optical coupler;
a plurality of first lenses formed on a bottom surface of the body, configured to focus light proceeding toward the respective optical elements or to prevent divergence of light emitted from the respective optical elements from diverging and to guide the light toward the optical fiber;
a plurality of second lenses formed on a surface opposite to the bottom surface of the body at positions corresponding to the respective first lenses, configured to focus light proceeding toward the respective optical elements or to prevent light emitted from the respective optical elements from diverging and direct it toward the optical fiber; and
a third lens configured to focus light emitted from the respective optical elements into the optical fiber or to prevent the divergence of light emitted from the optical fiber,
wherein each component within the optical coupler is integrally manufactured from a same material by molding.

2. The optical coupler of claim 1, wherein each component within the optical coupler is made of a lens material.

3. The optical coupler of claim 1, wherein the plurality of first lenses are disposed at positions facing the respective optical elements.

4. The optical coupler of claim 1, wherein the third lens is provided on an optical axis of the optical fiber.

5. The optical coupler of claim 1, wherein the third lens is provided to face the optical fiber inserted through the optical fiber inlet.

6. The optical coupler of claim 1, wherein the optical fiber inlet comprises an optical fiber inlet hole implemented with a predetermined depth from one end of the body in a direction opposite to the body.

7. The optical coupler of claim 6, wherein the optical fiber inlet hole has a diameter identical to a diameter of the optical fiber.

8. The optical coupler of claim 6, wherein the optical fiber inlet hole is provided at a position where light emitted from the respective optical elements is focused.

9. The optical coupler of claim 6, wherein the optical fiber inlet further comprises an optical fiber support jaw provided at a predetermined depth from the optical fiber inlet hole in the opposite direction of the body.

10. The optical coupler of claim 9, wherein the optical fiber support jaw has a structure protruding inward from the optical fiber inlet hole, thereby preventing the optical fiber from advancing further into the body.
